(19) United States
(12) Patent Application Publication
(10) Pub. No.: US 2019/0070684 A1
(43) Pub. Date: Mar. 7, 2019

(54) APPARATUS AND METHOD FOR REPAIRING DAMAGE TO PIPE COATINGS

(71) Applicant: Daniel Owen GUNN, Sherwood Park (CA)

(72) Inventor: Daniel Owen GUNN, Sherwood Park (CA)

(21) Appl. No.: 16/058,033

(22) Filed: Aug. 8, 2018

Related U.S. Application Data
(60) Provisional application No. 62/543,231, filed on Aug. 9, 2017.

(51) Int. Cl. B23K 1/002; H05B 6/06; H05B 6/14; H05B 6/40; G03G 15/20; F16L 55/18

(52) U.S. Cl. CPC B23K 1/002; H05B 6/06; H05B 6/14; F16L 55/163; G03G 15/2039; G03G 15/2053; F16L 55/18; H05B 6/40

(57) ABSTRACT

A handheld induction heater may be used to deliver heat to a coated steel pipe in a localized area of where the coating has been damaged, to heat the steel pipe to a high enough temperature for curing a coating repair material applied in the damaged area without causing heat damage to the existing coating. In one embodiment, the handheld induction heater has a main body housing two or more induction “pancake” coils. The main body is configured for conformation with the diameter of the specific pipe on which the induction heater is to be used. The main body may also incorporate electromagnets to hold the heater in place on the pipe during the heating cycle, as well as a thermocouple for sensing the temperature of the pipe so that the heater can be automatically shut off when the pipe reaches a preset temperature.

### FIELD OF THE DISCLOSURE

The present disclosure relates in general to apparatus and methods for repairing damaged coatings on steel pipe, such as (but not limited to) field repairs to shop-coated pipe used for oil and gas pipelines, and in particular (but not restrictively) to apparatus and methods for repairing smaller areas of coating damage, such as localized nicks and gouges.

### BACKGROUND

Pipelines for transmission of petroleum fluids such as crude oil and natural gas are typically constructed from sections of carbon steel pipe that are butt-welded end-to-end in the field. To help protect the pipe against corrosion, the exterior surface of each pipe section is typically coated with a suitable protective coating (such as but not limited to an epoxy coating), except for bare metal cutback zones at each end to facilitate field welding. The coating is most commonly shop-applied to the pipe sections for optimal quality control. After a field-welded joint has been made between two pipe sections, the weld area and adjacent cutback zones receive a field-applied coating matching or compatible with the shop-applied coating so as to provide continuity of corrosion protection along the full length of the completed pipeline.

It is common for shop-applied coatings on pipe sections to be inadvertently damaged, such as impact damage during loading and shipment of the coated pipe sections, as well as damage from mishandling of the coated pipe sections on the pipeline construction site. In addition, field-applied coatings in the weld area and cutback zones at field-welded pipe joints are susceptible to inadvertent damage. Regardless of where it occurs, such coating damage must be properly repaired before the pipeline can be considered ready for installation and burial in the pipe trench. This is true for any damage that might jeopardize the integrity and protective effectiveness of the coating, even for small and localized areas of coating damage.

Known methods for making field repairs to pipeline coatings include using a propane torch to heat the repair area and melt the existing coating so that it will flow into the damaged area (e.g., nicks or gouges) and/or to facilitate fusing of the existing coating material with any additional coating material that might be applied to the damaged area for purposes of the repair. This method has numerous drawbacks, including:
The open torch flame may be unsafe for operations in certain areas.
The open flame can injure operators if mishandled or pointed in the wrong direction.
Heavy propane tanks need to be carried to the coating repair site.
Open flames are increasingly being banned from construction projects.
The torch nozzle quickly reaches a high temperature after the flame is lit, thus creating the risk of serious burns to the operator even after the flame has been turned off.
The high-temperature flame may damage the parent coating while trying to heat up the area for repair using a torch.

Another known pipe coating repair method involves the use of a heat gun that directs heated air against the coating repair. However, heat guns typically do not provide sufficient heat to properly heat the affected coating area, or else they provide too much heat and therefore damage the existing coating. As well, the heat from a heat gun typically cannot heat the steel pipe to a sufficient temperature such that the pipe can provide the necessary heat to cure the repair coating material (or at least not without first causing undesirable damage to the existing coating). In addition, heat gun nozzles become very hot and thus pose a burn risk if mishandled by an operator.

A further known pipe coating repair method involves positioning a full-size circumferential induction heater coil around the pipe so as to surround the area being repaired. Induction heating apparatus of this type is commonly used to pre-heat the weld zone at pipeline field joints preparatory to field-coating of the weld zone and adjacent cutback areas, and is quite effective for purposes of field repairs to pipe coatings. However, it is very inefficient to use such comparatively large apparatus to repair small areas of coating damage, due to significant costs (e.g., rental charges, operating costs, and maintenance costs) associated with the induction heating apparatus and the generator (typically a 100 kW generator) required to operate it, plus the large assets typically needed to transport the heating coil and generator (such as a crane truck with a side boom and a custom trailer).

For the foregoing reasons, there is a need for improved and more efficient apparatus and methods for making field repairs to small areas of damage to pipeline coatings.

### BRIEF SUMMARY

The present disclosure teaches apparatus and methods for repairing damaged pipeline coatings using a handheld induction heater that delivers heat in a localized area of a coated steel pipe, so as to quickly and efficiently heat the steel pipe to a sufficient temperature for curing an applied repair coating material without causing heat damage to the existing coating. In one embodiment, the handheld induction heater has a main body which houses a pair of 6-inch-diameter induction “pancake” coils connected in parallel. The main body is dimensionally configured to suit the diameter of the specific pipe on which the induction heater is to be used. Optionally, the main body may also incorporate one or more electromagnets to hold the heater in place on the pipe during the heating cycle, and a thermocouple for sensing the temperature of the pipe so that the heater can be automatically shut off when the pipe reaches a preset temperature. Suitable electrical connectors are provided for connecting the heating coils, the electromagnets, and the thermocouple to a suitable power source (such as a 5.0 to 6.5 kW induction generator, which typically will be sufficient for repairing small damaged coating areas). Preferably, the main body is also provided with a suitable handle to allow an operator to manipulate the handheld induction heater.

Advantages of using a handheld induction heater in accordance with the present disclosure for purposes of repairing damaged pipe coatings include the following:
Induction heating penetrates the thickness of the steel pipe to heat the pipe evenly.
There is no open flame, and thus no related safety hazard.
The handheld induction heater does not get hot to the touch, even immediately after use, and thus does not pose a burn hazard to the operator.
Operation of the handheld induction heater does not damage the existing coating, because induction heating only heats ferrous metals; the existing coating on a steel pipe is heated by heat transfer from the heated steel pipe.
The handheld heater is comparatively light in weight, and can be manipulated by a single operator.
The handheld heater can be “tuned” to heat the steel pipe to a specific target temperature and then to be automatically shut off, thus preventing excessive heating due to operator error.
The heating process is automatic: once the target pipe temperature has been set, the operator merely needs to turn on the heater and wait.
The handheld induction heater does not require heavy equipment for transport and support.

Accordingly, in one aspect the present disclosure teaches an induction heating apparatus comprising an induction generator and an induction heater, wherein the induction heater has a main body made from non-electrically-conductive materials, and houses one or more induction coils. The induction heater is adapted to receive electrical power from the induction generator to energize the one or more induction coils. A bottom portion of the main body is shaped to substantially conform to the shape of an external surface of a steel workpiece on which the induction heater is to be mounted. The configuration and weight of the induction heater are such that the induction heater can be lifted and manipulated by one or more human operators without using auxiliary handling apparatus.

The induction heater may include one or more electromagnets for maintaining the induction heater in a desired position on a steel workpiece.

The induction heater may also include a thermocouple, and may be programmable to de-energize the induction coils when the temperature of the steel workpiece reaches a preset temperature, as sensed by the thermocouple.

In some embodiments, the induction generator has a power generation capability not exceeding 10 kilowatts. In one particular embodiment the induction generator has a power generation capability between about 5 kilowatts and about 6.5 kilowatts.

The main body of the induction heater may have a rectilinear perimeter, but this is by way of non-limiting example only. In variant embodiments, the perimeter of the main body could be of curvilinear, polygonal, or any other geometrical configuration.

In another aspect, the present disclosure teaches a method for repairing a coating on a steel workpiece, including the steps of:
providing an induction heating apparatus as described above;
positioning the induction heater of the induction heating apparatus over a selected region of an external surface of a coated steel workpiece;
actuating the induction generator of the induction heater of the induction heating apparatus to energize the one or more induction coils of the induction heater;
de-energizing the induction heater when the temperature of the coated steel workpiece in the selected region has reached a selected target temperature; and
disengaging the induction heater from the coated steel workpiece.

### BRIEF DESCRIPTION OF THE DRAWINGS

Embodiments will now be described with reference to the accompanying Figures, in which numerical references denote like parts, and in which:

FIG. 1 is an isometric view of one embodiment of an induction heating apparatus in accordance with the present disclosure, comprising a handheld induction heater and an induction generator.

FIG. 2 is an isometric view of the handheld induction heater of the apparatus shown in FIG. 1.

FIG. 3 is an isometric view of a second embodiment of a handheld induction heater in accordance with the present disclosure, incorporating electromagnets.

FIG. 4 is a top view of the handheld induction heater in FIG. 3.

FIG. 5 is an end view of the handheld induction heater in FIG. 3, illustrating electrical connectors for connection to the induction generator.

FIG. 6 is a bottom view of the handheld induction heater in FIG. 3.

FIG. 7 is a partially-exploded view of the handheld induction heater in FIG. 3, illustrating induction coils housed within the main body of the induction heater.

FIG. 8 is a bottom view of the handheld induction heater in FIG. 3, with the bottom cover of the main body removed to show the induction coils housed therein.

FIG. 9 is an isometric view of an induction heater in accordance in the present disclosure, shown positioned on the external circumferential surface of a coated steel pipe for purposes of repairing a damaged area of the coating (power cables and electromagnets not shown).

### DETAILED DESCRIPTION

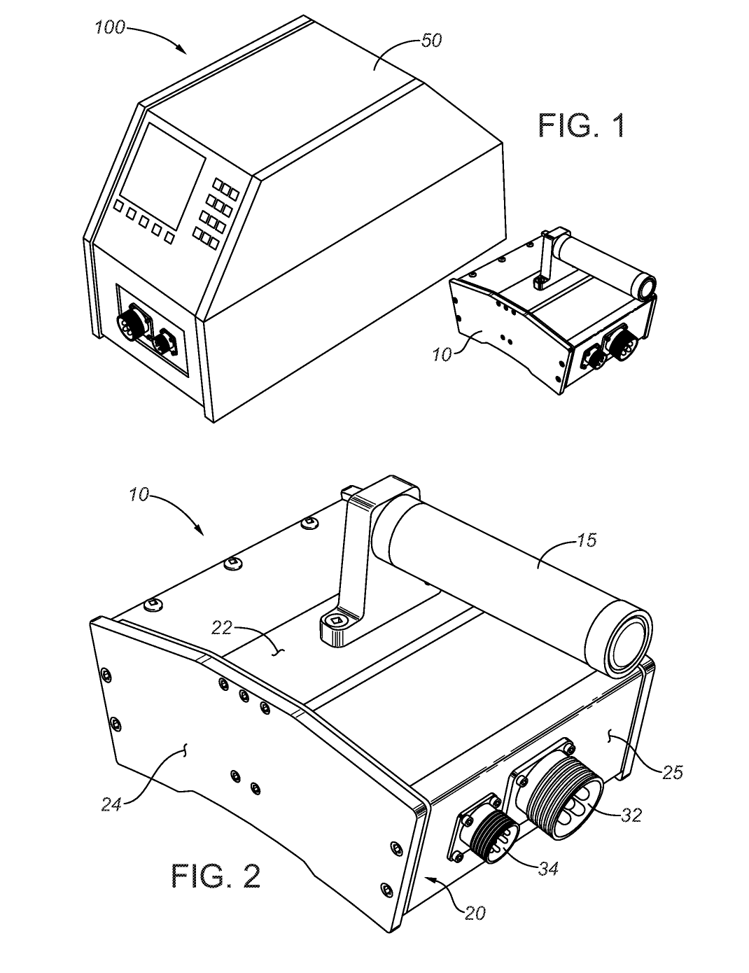

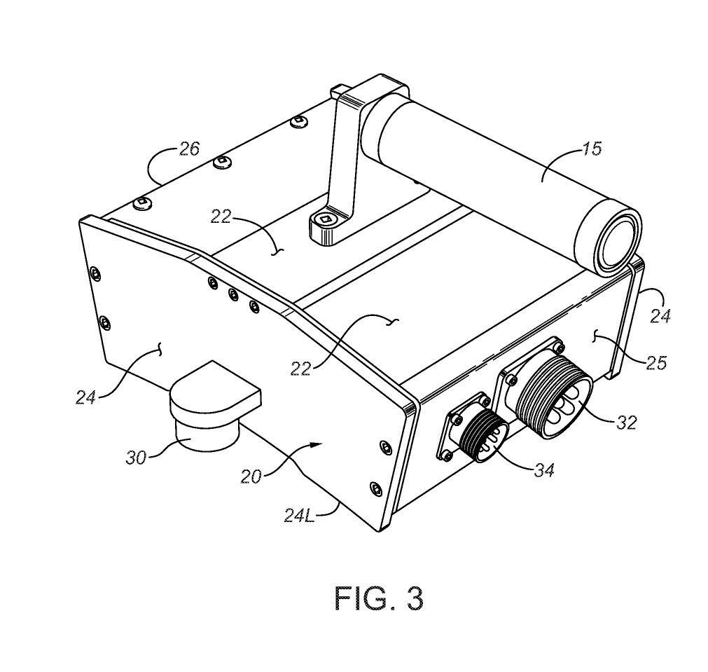

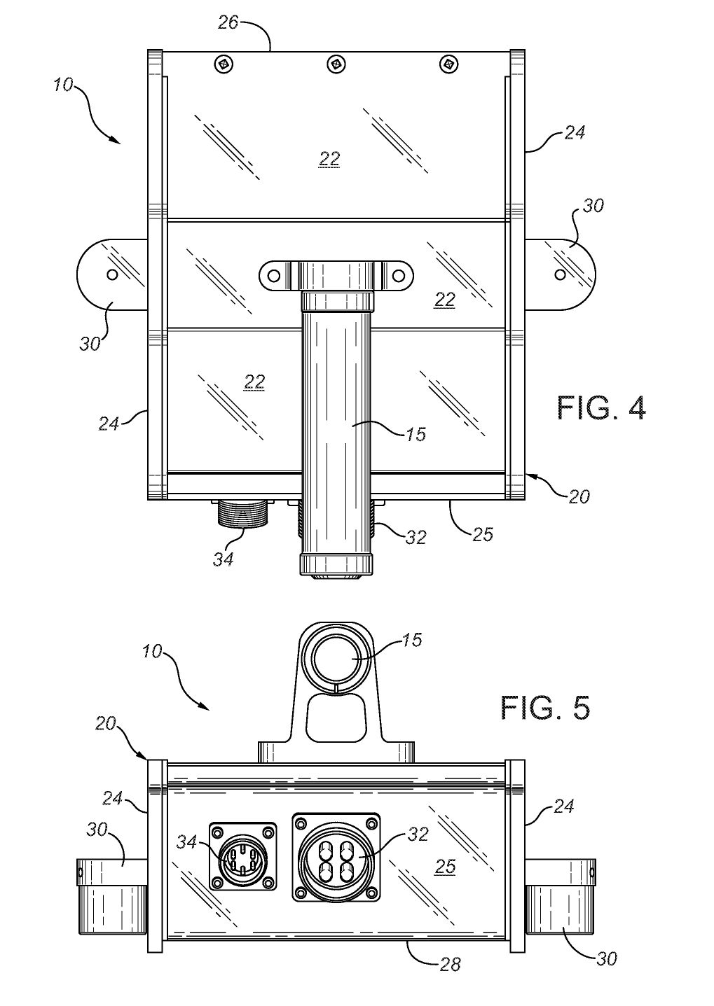

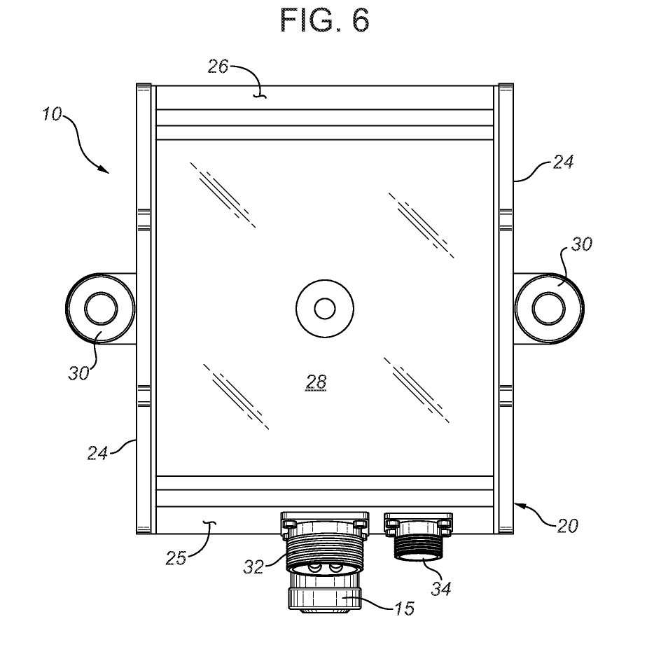

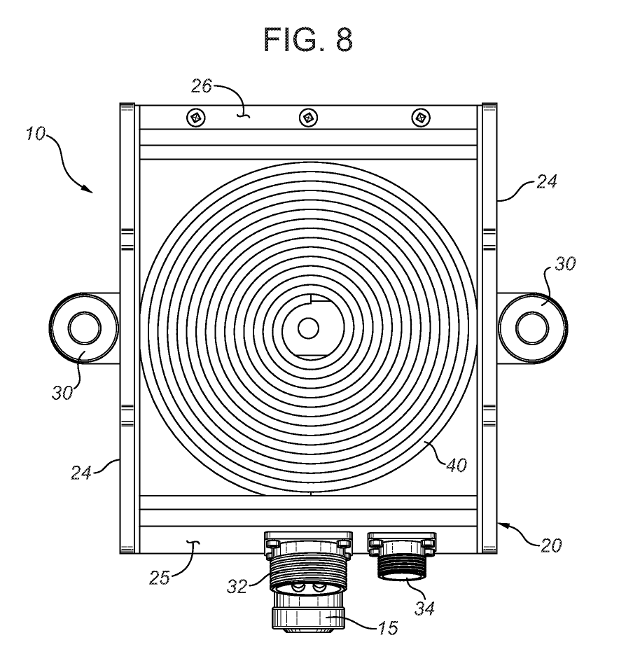

FIGS. 1 and 2 illustrate an embodiment of an induction heating apparatus 100 in accordance with the present disclosure, comprising a handheld induction heater 10 and an induction generator 50 for supplying electrical power to induction heater 10. FIGS. 3-8 illustrate a variant of the induction heater 10 shown in FIGS. 1 and 2.

In the particular embodiment shown in FIGS. 3-8, induction heater 10 comprises a main body 20 which forms an enclosure having a top cover 22 extending between a pair of opposing sidewalls 24; a rear wall 25; and a front wall 26. These components of main body 20 are preferably made from high-strength, non-electrically-conductive materials with good resistance to high temperatures and chemicals, such as (by way of non-limiting example) G10 FR-4 glass epoxy composite laminate or black polycarbonate sheets. Fasteners used to connect the components of main body 20 will preferably be made from stainless steel or other material that is a poor conductor or non-conductor of electricity.

Preferably, a handle 15 (of any suitable type) is affixed to top cover 22 to facilitate handling and positioning of induction heater 10 by an operator. The lower edges 24L of sidewalls 24 are preferably shaped or contoured to conform with the profile of a particular workpiece having a coating requiring repair using induction heater 10. In this regard, it should be noted that although induction heater 10 is primarily intended for repairing coatings on circular pipe, it is also adaptable for use on other coated steel articles including articles with flat coated surfaces or other configurations.

It should also be noted that although the illustrated main body 20 of induction heater 10 has a generally rectilinear configuration, this is by way of example only, as there is no requirement for main body 20 to be of any particular geometric shape. For example, variant embodiments of main body 20 or portions thereof could have a generally curvilinear or other non-rectilinear configuration without departing from the scope of the present disclosure.

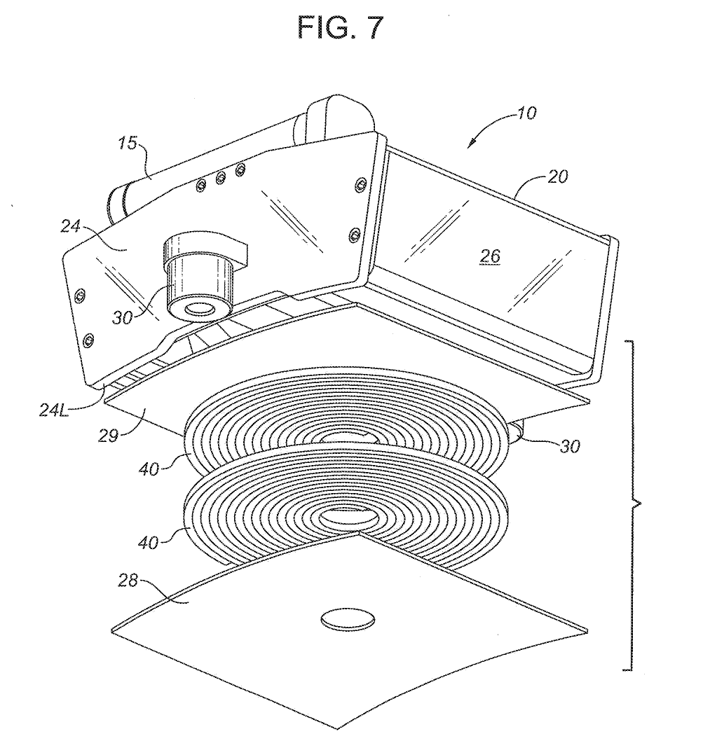

In the illustrated embodiment, induction heater 10 includes two electromagnets 30, each being mounted to and extending outward from an associated one of the sidewalls 24, to facilitate positioning of induction heater 10 on the surface of a coated steel workpiece. A pair of circular (“pancake”) induction coils 40 are “stacked” within main body 20, as best seen in FIG. 7. This is by way of example only, as variant embodiments may use only a single induction coil or could use three or more induction coils. In embodiments using two or more induction coils, the induction coils will typically be connected in parallel. Prototype embodiments of induction heater 10 have used 6-inch-diameter 8 AWG 660/36 Litz wire induction coils, but this is by way of example only. Alternative embodiments could use induction coils of different size, shape, and/or power without departing from the scope of the present disclosure. As shown in in FIG. 7, induction coils 40 are disposed between an bottom cover plate 28 and an inner bottom cover plate 29 (preferably but not necessarily made from the same type of materials as the other components of main body 20), which are fastened to main body 20 as appropriate at the bottom edges of sidewalls 24, rear wall 25, and front wall 26.

Although not shown in the Figures, main body 20 preferably (but not necessarily) houses a suitable thermocouple (for example, a Type K thermocouple) for monitoring the temperature of a coated steel workpiece so that induction heater 10 can be programmed to shut off the power supply when the workpiece reaches a preset target temperature.

Referring now to FIGS. 2, 5, 6, and 8 in particular, a first power receptacle 32 and a second power receptacle 34 are mounted in rear wall 25 of main body 20. First power receptacle 32 is for connecting the main power from induction generator 50 to induction coils 40, and second power receptacle 34 is for connecting electromagnets 30 and the thermocouple to a secondary power source associated with induction generator 50.

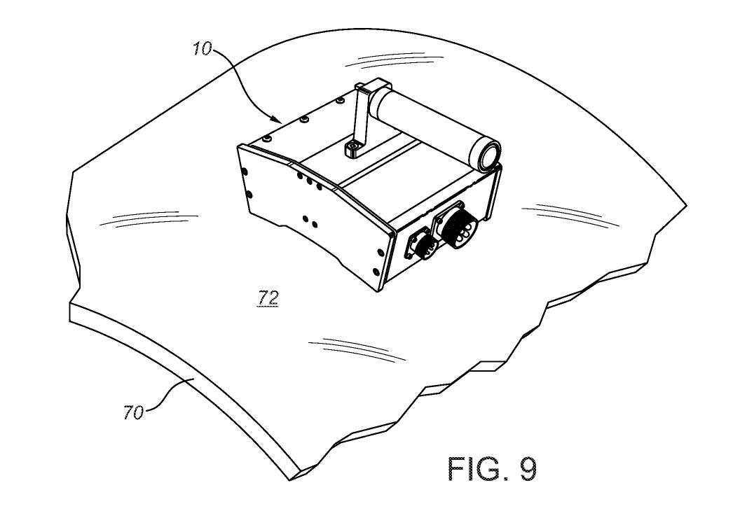

FIG. 9 generally illustrates how induction heater 10 may be positioned on a steel pipe 70 having a coating 72, for purposes of making localized repairs to coating 72.

In one embodiment of a method for repairing a coating on a steel workpiece using apparatus in accordance with the present disclosure, the procedure will typically include the following steps:
1. Operator manipulates the handheld induction heater over the damaged area of the coating on the steel workpiece.
2. Operator engages the electromagnets magnets (optionally using a remote control).
3. Operator activates the induction heater (using a start button on either the induction heater or a remote control).
4. The steel workpiece is automatically heated to a target temperature programmed into the induction heater (with the workpiece temperature, as read by the thermocouple, preferably being displayed on the induction heater and/or remote control).
5. A light on the induction heater and/or the remote control indicates completion of the heating cycle, whereupon the operator disengages the electromagnets and removes the handheld induction heater from the work piece.
6. Normal coating repair operations are then carried out, with heat from the induction-heated steel workpiece being effective either to melt the existing coating, or to melt additional coating material and fuse it with the existing coating area, and in either case restoring coating continuity over the damaged area.

It will be readily appreciated by those skilled in the art that various alternative embodiments of the disclosed induction heating apparatus may be devised without departing from the scope of the present teachings, including modifications that may use equivalent structures or materials subsequently conceived or developed. It is to be especially understood that it is not intended for apparatus in accordance with the present disclosure to be limited to any particular described or illustrated embodiment, and that the substitution of a variant of a claimed or disclosed element or feature, without any substantial resultant change in the working of the apparatus, will not constitute a departure from the scope of the disclosure.

In this patent document, any form of the word “comprise” is to be understood in its non-limiting sense to mean that any item following such word is included, but items not expressly mentioned are not excluded. A reference to an element by the indefinite article “a” does not exclude the possibility that more than one such element is present, unless the context clearly requires that there be one and only one such element. Any use of any form of the words “connect”, “engage”, or any other term describing an interaction between elements is not intended to limit that interaction to direct interaction between the subject elements, and may also include indirect interaction between the elements such as through secondary or intermediary structure.

Wherever used in this document, the terms “typical” and “typically” are to be interpreted in the sense of being representative of common usage or practice, and are not to be understood as implying invariability or essentiality.

What is claimed is:

1. An induction heating apparatus comprising an induction generator and an induction heater, wherein:
(a) the induction heater comprises a main body made from non-electrically-conductive materials, and houses one or more induction coils;
(b) the induction heater is adapted to receive electrical power from the induction generator to energize the one or more induction coils;
(c) a bottom portion of the main body is shaped to substantially conform to the shape of an external surface of a steel workpiece on which the induction heater is to be mounted; and
(d) the configuration and weight of the induction heater are such that the induction heater can be lifted and manipulated by one or more human operators without using auxiliary handling apparatus.

2. An induction heating apparatus as in claim 1, wherein the induction heater further comprises one or more electromagnets for maintaining the induction heater in a desired position on a steel workpiece.

3. An induction heating apparatus as in claim 1, wherein the induction heater further comprises a thermocouple for detecting the temperature of the steel workpiece.

4. An induction heating apparatus as in claim 3, wherein the induction heater is programmable to de-energize the induction coils when the temperature of the steel workpiece reaches a preset temperature, as sensed by the thermocouple.

5. An induction heating apparatus as in claim 1 wherein the main body of the induction heater is made from one or more non-electrically conductive materials selected from the group consisting of glass epoxy composite laminate, black polycarbonate sheets, and stainless steel.

6. An induction heating apparatus as in claim 1 wherein the external surface of the steel workpiece comprises a cylindrical surface.

7. An induction heating apparatus as in claim 1 wherein the induction generator has a power generation capability not exceeding 10 kilowatts.

8. An induction heating apparatus as in claim 7 wherein the induction generator has a power generation capability between approximately 5 kilowatts and 6.5 kilowatts.

9. An induction heating apparatus as in claim 1 wherein the main body of the induction heater includes a top cover, a bottom cover, and one or more sidewalls extending between the top and bottom covers.

10. An induction heating apparatus as in claim 9 wherein the one or more sidewalls define a rectilinear sidewall perimeter.

11. An induction heating apparatus as in claim 9 wherein the one or more sidewalls comprise a curvilinear sidewall perimeter.

12. A method for repairing a coating on a steel workpiece, said method comprising the steps of:
(a) providing an induction heating apparatus as in claim 1;
(b) positioning the induction heater of the induction heating apparatus over a selected region of an external surface of a coated steel workpiece;
(c) actuating the induction generator of the induction heater of the induction heating apparatus to energize the one or more induction coils of the induction heater;
(d) de-energizing the induction heater when the temperature of the coated steel workpiece in the selected region has reached a selected target temperature; and
(e) disengaging the induction heater from the coated steel workpiece.

13. A method as in claim 12, comprising the further step of adding additional coating material to the selected region of the coated steel workpiece after the selected target temperature has been reached.

14. A method as in claim 12 wherein the induction heater includes one or more electromagnets for maintaining the induction heater in a desired position on a steel workpiece, and wherein the method comprises the further step of energizing the one or more electromagnets after the induction heater has been positioned on the coated steel workpiece.

15. A method as in claim 12 wherein:
(a) the induction heater includes a thermocouple for detecting the temperature of the coated steel workpiece;
(b) the induction heater is programmable to disconnect the electrical power supply to the one or more induction coils when the temperature of the steel workpiece reaches a preset target temperature, as sensed by the thermocouple; and
(c) the step of de-energizing the induction heater is automatically initiated when the thermocouple detects that the target temperature of the coated steel workpiece has been reached.
